(19) United States
(12) Patent Application Publication
(10) Pub. No.: US 2026/0361763 A1
(43) Pub. Date: Nov. 12, 2026

(54) IMAGE FORMING APPARATUS, CONTROL METHOD, AND NON-TRANSITORY COMPUTER-READABLE RECORDING MEDIUM

(71) Applicant: Konica Minolta, Inc., Tokyo (JP)

(72) Inventors: Shoko HABA, Osaka (JP); Kazuhiro TOMIYASU, Toyokawa-shi (JP)

(21) Appl. No.: 19/668,168

(22) Filed: May 5, 2026

(30) Foreign Application Priority Data
May 7, 2025 (JP) 2025-077527

(51) Int. Cl. H04L 9/40; H04N 1/00; H04N 1/44

(52) U.S. Cl. CPC H04L 63/145; H04N 1/00037; H04N 1/00074; H04N 1/00082; H04N 1/00244; H04N 1/00347; H04N 1/00925; H04N 1/44

(57) ABSTRACT

An image forming apparatus that performs virus detection processing on data using a pattern file, includes a storage section that stores the pattern file, and a controller that updates the pattern file stored in the storage section. When updating the pattern file, the controller selects, on a priority basis, an image forming apparatus whose pattern file is to be updated preferentially from among a plurality of image forming apparatuses including another image forming apparatus connected to a network and the image forming apparatus itself, and notifies a user of the selected image forming apparatus.

### CROSS REFERENCE TO RELATED APPLICATIONS

This application is based on Japanese Patent Application No. 2025-077527 filed on May 7, 2025, the entire contents of which are incorporated herein by reference.

### BACKGROUND OF THE INVENTION

### Technical Field

The present invention relates to an image forming apparatus, a control method, and a non-transitory computer-readable recording medium. In particular, the present invention relates to a technique for updating a pattern file for detecting a computer virus in an image forming apparatus.

### Description of Related Art

An image forming apparatus, such as a multifunction peripheral (MFP) installed in an office, is shared by a plurality of users and has a plurality of functions, such as scanning, printing, and copying functions. The image forming apparatus receives data to be printed and transmits image data generated by a scan function via a network. This type of image forming apparatus may be infected with a computer virus. Hereinafter, a computer virus is simply referred to as a "virus".

If, in the unlikely event that the image forming apparatus is infected with a virus, the virus may spread to other devices connected to the network. In addition, an image forming apparatus infected with a virus may leak confidential information such as customer information. For this reason, in recent years, an image forming apparatus, like a general personal computer (PC) or the like, has been provided with a virus detection function for preventing virus infection. An image forming apparatus having a virus detection function is disclosed in, for example, Japanese Unexamined Patent Publication No. JP2024-305A and Japanese Unexamined Patent Publication No. JP2006-178744A.

A pattern file is used for virus detection. The pattern file is an electronic file that defines patterns, such as characteristics of viruses, and stores patterns of various viruses. This pattern file is sequentially updated, on a server apparatus accessible via the Internet, to a file corresponding to the latest viruses. Therefore, the image forming apparatus can detect the latest viruses by downloading the latest-version pattern file from the server apparatus through online communication via the Internet and using the pattern file for virus detection.

However, in an office environment in which an image forming apparatus is installed, the local network to which the image forming apparatus is connected may be isolated from an external network such as the Internet. In such an environment, the image forming apparatus cannot access an external server apparatus and cannot download the latest-version pattern file. In this case, the user is required to download the latest-version pattern file from the server apparatus using a personal computer (PC) or the like that is connectable to the Internet. Then, the user stores the downloaded pattern file in a storage device such as a USB memory. Thereafter, the user connects the storage device to the image forming apparatus, and updates, using the pattern file stored in the storage device, the pattern file in the image forming apparatus. For example, when a plurality of image forming apparatuses is connected to a local network, the user performs, for each image forming apparatus, an operation of connecting the storage device and updating the pattern file.

Incidentally, the plurality of image forming apparatuses has different configuration settings. For example, the plurality of image forming apparatuses may include an apparatus in which a data transmission/reception function is enabled and an apparatus in which the data transmission/reception function is disabled. An image forming apparatus in which a data transmission/reception function is enabled transmits data to another apparatus via a local network, and thus may spread a virus. On the other hand, an image forming apparatus in which the data transmission/reception function is disabled does not transmit data to another apparatus, and thus has no possibility of spreading a virus. Therefore, an image forming apparatus in which the data transmission/reception function is enabled has a higher priority for applying the latest version of the pattern file than an image forming apparatus in which the data transmission/reception function is disabled. However, there is a problem in that the user does not know, among the plurality of image forming apparatuses, which image forming apparatus should have its pattern file updated on a priority basis.

### SUMMARY OF THE INVENTION

The present invention has been made to solve the above-described problem, and an object of the present invention is to provide an image forming apparatus, a control method, and a non-transitory computer-readable recording medium that enable a user to update, for each of a plurality of image forming apparatuses, a pattern file in an optimal order.

To achieve at least one of the abovementioned objects, according to an aspect of the present invention, an image forming apparatus reflecting an aspect of the present invention performs virus detection processing on data using a pattern file. The image forming apparatus includes a storage section that stores the pattern file and a controller that updates the pattern file stored in the storage section. When updating the pattern file, the controller selects, on a priority basis, an image forming apparatus whose pattern file is to be updated preferentially from among a plurality of image forming apparatuses including another image forming apparatus connected to a network and the image forming apparatus itself, and notifies a user of the selected image forming apparatus.

### BRIEF DESCRIPTION OF THE DRAWINGS

The advantages and features provided by one or more embodiments of the invention will become more fully understood from the detailed description given hereinbelow and the appended drawings, which are given by way of illustration only and thus are not intended to define the limits of the present invention.

FIG. 1 is a conceptual diagram illustrating an overall configuration of a network system including an image forming apparatus;

FIG. 2 is a diagram illustrating an example hardware configuration of the image forming apparatus;

FIG. 3 is a diagram illustrating an example of setting information;

FIG. 4 is a diagram illustrating a functional configuration of the controller;

FIG. 5 is a diagram illustrating an example of supplementary information;

FIG. 6 is a diagram illustrating an example operation in which an image forming apparatus acquires apparatus information from another image forming apparatus;

FIG. 7 is a diagram illustrating installation locations of a plurality of image forming apparatuses in an office environment;

FIG. 8 is a flowchart illustrating a main processing procedure performed by the controller of the image forming apparatus;

FIG. 9 is a flowchart showing details of first update processing executed when the urgency is "medium";

FIG. 10 is a flowchart showing details of a priority apparatus selection process;

FIG. 11 is a diagram illustrating a device list;

FIG. 12 is a diagram illustrating an example of a status list;

FIG. 13 is a diagram illustrating a device list sorted by risk point in descending order;

FIG. 14 is a diagram illustrating an example of a pattern file update screen displayed on the image forming apparatus;

FIGS. 15A and 15B are diagrams illustrating an example of a pattern file update screen displayed on the image forming apparatus;

FIG. 16 is a diagram illustrating an update order in which a user updates a pattern file when the urgency is "medium";

FIG. 17 is a flowchart illustrating details of the second update processing executed when the urgency is "urgent";

FIG. 18 is a flowchart illustrating details of the second update processing executed when the urgency is "urgent";

FIG. 19 is a diagram illustrating an update order in which a user updates a pattern file when the urgency is "urgent";

FIG. 20 is a flowchart illustrating details of the third update processing executed when the urgency is "important";

FIG. 21 is a flowchart illustrating details of the third update processing executed when the urgency is "important";

FIG. 22 is a diagram illustrating an order in which a user updates a pattern file when the urgency is "important"; and

FIG. 23 is a flowchart illustrating details of the fourth update processing executed when the urgency is "low".

### DETAILED DESCRIPTION OF EMBODIMENTS

Hereinafter, one or more embodiments of the present invention will be described with reference to the drawings. However, the scope of the invention is not limited to the disclosed embodiments. In the embodiments described below, the same reference signs denote the same or corresponding elements, and redundant description thereof is omitted.

### Preferred Embodiment

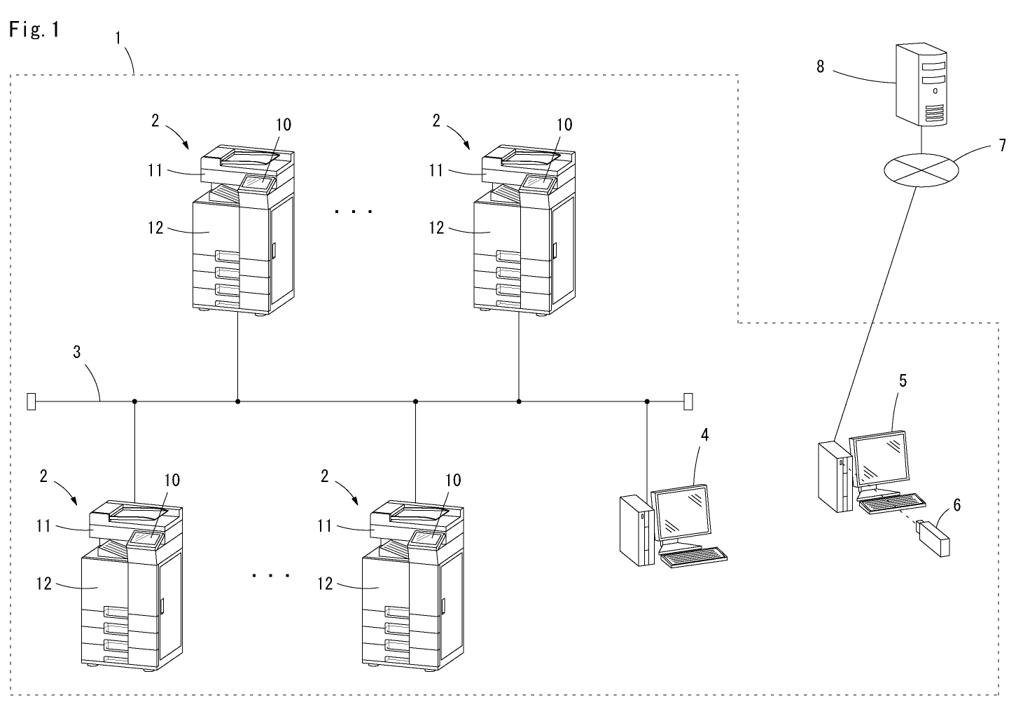

FIG. 1 is a conceptual diagram illustrating an overall configuration of a network system including image forming apparatus 2 according to an embodiment of the present invention. This network system is a system constructed in an office environment 1. The network system includes a network 3 such as a local area network (LAN), and a plurality of image forming apparatus 2 are connected to the network 3. Further, an information processing apparatus 4 such as a personal computer (PC) is connected to the network 3. The network 3 is isolated from an external network 7 such as the Internet.

The office environment 1 is provided with an information processing apparatus 5 that is different from the information processing apparatus 4. The information processing apparatus 5 is not connected to the network 3. However, the information processing apparatus 5 is connected to an external network 7 such as the Internet. Accordingly, the information processing apparatus 5 can communicate with the server apparatus 8 provided in the cloud via the external network 7.

The image forming apparatus 2 is configured as, for example, a multifunction peripheral (MFP), and includes an operation panel 10, a scanner unit 11, and a printer unit 12. The operation panel 10 is a user interface for a user when using the image forming apparatus 2. The scanner unit 11 optically reads an image of a document placed by a user and generates image data. The printer unit 12 forms an image on a sheet, such as printing sheet, and outputs the sheet based on image data to be printed. The image forming apparatus 2 executes, by operating the scanner unit 11 or the printer unit 12, a job designated by a user, such as a scan job, a print job, or a copy job.

The image forming apparatus 2 includes a virus detection function to prevent virus infection. Accordingly, the image forming apparatus 2 can perform virus detection processing on data received via the network 3 and data to be transmitted. The virus detection processing is performed on the basis of a pattern file stored in advance in the image forming apparatus 2. The pattern file is an electronic file that defines patterns such as characteristics of various viruses. Therefore, in the virus detection processing, a virus that is not defined in the pattern file cannot be detected.

The server apparatus 8 is a server that provides the latest-version pattern file including an added pattern for a new virus, thereby enabling detection of the new virus in the virus detection processing. However, the network 3 to which the image forming apparatus 2 is connected is not connected to the external network 7. Therefore, the image forming apparatus 2 cannot acquire, by itself, the latest-version pattern file provided by the server apparatus 8.

Accordingly, the user of the image forming apparatus 2 operates the information processing apparatus 5 to access the server apparatus 8 and download the latest-version pattern file from the server apparatus 8 to the information processing apparatus 5. The user stores, in the storage device 6 such as a USB flash memory, the pattern file downloaded to the information processing apparatus 5. The user connects the storage device 6 storing the pattern file to the image forming apparatus 2, and updates the pattern file stored in the image forming apparatus 2. In particular, the user sequentially updates the pattern file, one by one, for each of the plurality of image forming apparatuses 2 installed in the office environment 1.

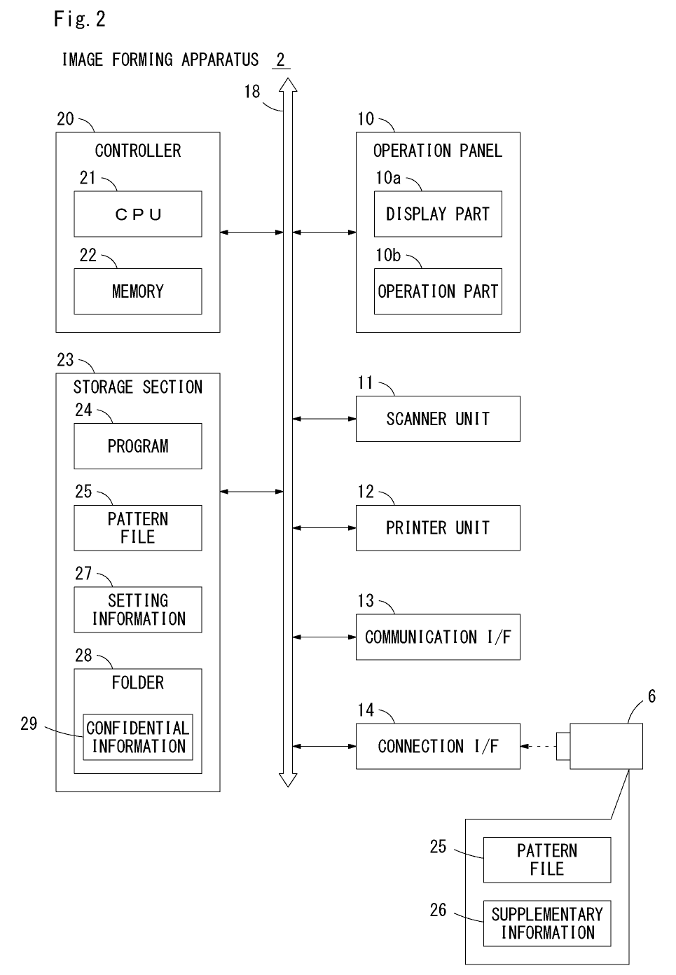

FIG. 2 is a diagram illustrating an example hardware configuration of the image forming apparatus 2. The image forming apparatus 2 includes an operation panel 10, a scanner unit 11, a printer unit 12, a communication interface 13, a connection interface 14, a controller 20, and a storage section 23. These units are connected to a bus 18 provided inside the image forming apparatus 2, and are capable of inputting and outputting data to and from each other. The controller 20 controls the operations of the respective units via the bus 18, and overall controls the image forming apparatus 2.

The operation panel 10 includes a display part 10a and an operation part 10b. The display part 10a includes, for example, a color liquid crystal display, and displays various operation screens operable by the user. The operation part 10b includes, for example, touchscreen keys disposed on a screen of the display part 10a, and receives user operations.

The communication interface 13 is an interface that communicates via the network 3. The controller 20 communicates, via the communication interface 13, with other image forming apparatuses 2 and information processing apparatuses 4 that are connected to the network 3.

The connection interface 14 is an interface for connecting a storage device 6 such as a USB flash memory. The controller 20 reads out and acquires data stored in the storage device 6 via the connection interface 14. For example, data downloaded from the server apparatus 8 is stored in the storage device 6. In the example of FIG. 2, the storage device 6 stores a pattern file 25 and supplementary information 26. The supplementary information 26 is information that is downloaded from the server apparatus 8 together with the pattern file 25.

The controller 20 includes a CPU 21 and a memory 22. The CPU 21 is a hardware processor that reads out and executes a computer-readable program 24 stored in the storage section 23. The memory 22 is a volatile memory that stores data generated when the CPU 21 executes the program 24, and is used as a work area for the CPU 21.

The storage section 23 is a nonvolatile storage device including a hard disk drive (HDD), a solid-state drive (SSD), or the like. The storage section 23 stores a program 24 to be executed by the CPU 21, a pattern file 25 used in virus detection processing, and setting information 27 defining basic settings of the image forming apparatus 2. In addition, the storage section 23 is provided with a folder 28 that is a storage area for storing various data acquired or generated in association with execution of a job in the image forming apparatus 2. The storage section 23 may be provided with a plurality of folders 28. Confidential information 29 may be stored in such a folder 28.

The image forming apparatus 2 includes a confidential-information holding function, a data transmission/reception function, and a shared folder function. The confidential-information holding function is configured to store the confidential information 29 in the folder 28 and to set an access right for the folder 28 in which the confidential information 29 is stored. The confidential-information holding function can be switched between enabled and disabled in the image forming apparatus 2. Therefore, when an access right is set for the folder 28 in which the confidential information 29 is stored, the confidential-information holding function needs to be enabled in advance in the image forming apparatus 2.

The data transmission/reception function is a function of transmitting and receiving data via the network 3 in association with the execution of a job. When the data transmission/reception function is enabled, for example, the image forming apparatus 2 can transmit image data generated in a scan job to another image forming apparatus 2 or the information processing apparatus 4 via the network 3. The data transmission/reception function can be switched between enabled and disabled in the image forming apparatus 2. For example, when the data transmission/reception function is disabled, the image forming apparatus 2 prevents data generated in association with execution of a job from leaking to the network 3.

The shared folder function is a function for sharing the folder 28 with other image forming apparatuses 2 or the information processing apparatus 4 via the network 3. When the shared folder function is enabled, the image forming apparatus 2 makes the folder 28 designated to be shared available to other apparatuses connected to the network 3. In contrast, when the shared folder function is disabled, the image forming apparatus 2 does not make the folder 28 provided in the storage section 23 available to other apparatuses. The shared folder function can be switched between an enabled state and a disabled state in the image forming apparatus 2. For example, when the shared folder function is disabled, the image forming apparatus 2 prevents data stored in the folder 28 from leaking to other apparatuses.

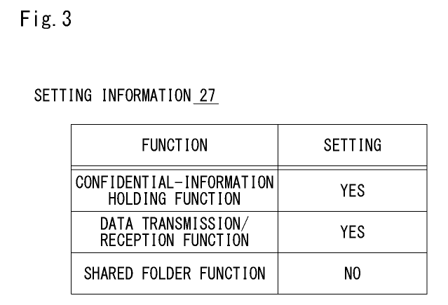

The setting information 27 is information defining setting states of the confidential-information holding function, the data transmission/reception function, and the shared folder function. FIG. 3 is a diagram illustrating an example of the setting information 27. As shown in FIG. 3, the setting information 27 stores a setting of "YES" or "NO" for each of the confidential-information holding function, the data transmission/reception function, and the shared folder function. "YES" is a setting indicating that the function is enabled. "NO" is a setting indicating that the function is disabled. Accordingly, the setting information 27 shown in FIG. 3 indicates that the confidential-information holding function and the data transmission/reception function are enabled, and that the shared folder function is disabled.

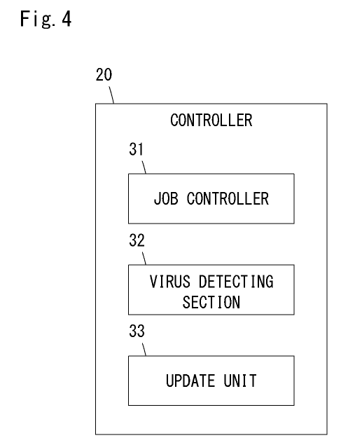

FIG. 4 is a diagram illustrating a functional configuration of the controller 20. By executing the program 24, the CPU 21 causes the controller 20 to function as a job controller 31, a virus detecting section 32, and an update unit 33, as illustrated in FIG. 4.

The job controller 31 comprehensively controls execution of a job in the image forming apparatus 2. For example, in the case of a copy job, the job controller 31 drives the scanner unit 11 and acquires image data of a document placed by a user. The job controller 31 then drives the printer unit 12 based on the image data and outputs a printed material on which an image of the document is copied.

In the case of a scan job, the job controller 31 drives the scanner unit 11 to acquire image data and outputs the image data to an output destination designated by a user. Note that, when the data transmission/reception function is disabled, the job controller 31 does not output image data to an external apparatus via the network 3.

In the case of a print job, the job controller 31 acquires image data to be printed and drives the printer unit 12 based on the image data. When the data transmission/reception function is disabled, the job controller 31 does not acquire image data to be printed from an external apparatus via the network 3.

The virus detecting section 32 reads a pattern file 25 stored in the storage section 23 and executes virus detection processing using the pattern file 25. For example, the virus detecting section 32 performs virus detection processing on data acquired in association with the execution of a job by the job controller 31, or on data to be output. Further, regardless of whether a job is executed, the virus detecting section 32 may execute virus detection processing on data input to the image forming apparatus 2 or data output from the image forming apparatus 2.

The update unit 33 updates the pattern file 25 used by the virus detecting section 32. For example, upon detecting a user instruction to update the pattern file 25 while the storage device 6 is connected to the connection interface 14, the update unit 33 operates. Then, the update unit 33 reads the supplementary information 26 stored in the storage device 6.

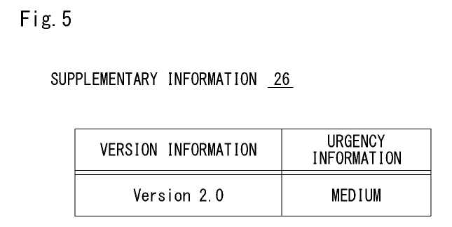

FIG. 5 is a diagram illustrating an example of the supplementary information 26. As shown in FIG. 5, the supplementary information 26 records version information of the pattern file 25 and urgency information. The version information indicates the version of the pattern file 25 that was downloaded from the server apparatus 8 together with the supplementary information 26. The urgency information indicates an urgency level when applying the pattern file 25 downloaded from the server apparatus 8.

For example, the urgency level indicated by the urgency information includes four levels: "urgent", "important", "medium", and "low". When the urgency level is "urgent", the pattern file 25 needs to be applied to the image forming apparatus 2 as early as possible, and immediate application is strongly recommended. When the urgency level is "important", the pattern file 25 is preferably applied to the image forming apparatus 2 as early as possible. However, when the urgency level is "important", instead of applying the pattern file 25 immediately, there is room to adjust the application schedule while ensuring the stability of the network system. When the urgency level is "medium", the pattern file 25 may be applied in accordance with a normal maintenance schedule. When the urgency level is "low", the pattern file 25 may be applied to the image forming apparatus 2 as necessary.

When the update unit 33 reads the supplementary information 26 as described above, the update unit 33 determines, based on the version information, whether the pattern file 25 stored in the storage section 23 is to be updated using the pattern file 25 stored in the storage device 6. In addition, the update unit 33 recognizes an urgency level for updating the pattern file 25 based on the urgency information included in the supplementary information 26. When the update unit 33 determines that the pattern file 25 stored in the storage section 23 is to be updated, the update unit 33 starts an update process in accordance with the urgency level.

When the update unit 33 starts the update process, the update unit 33 acquires apparatus information from other image forming apparatuses 2 via the network 3. At this time, the update unit 33 acquires apparatus information from all of the plurality of image forming apparatuses 2 connected to the network 3.

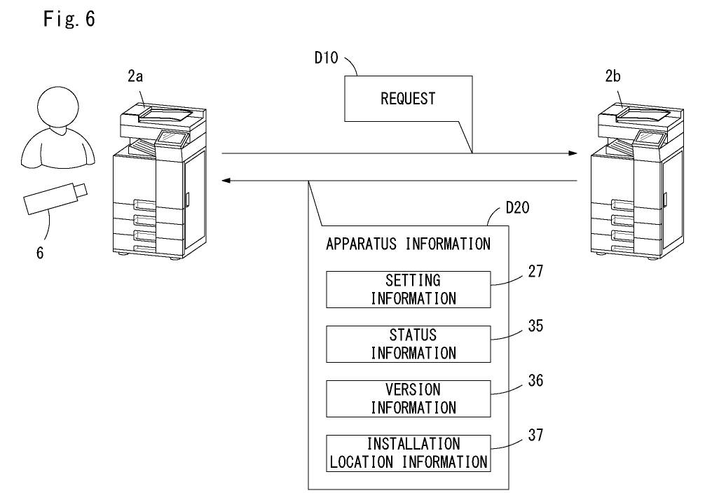

FIG. 6 is a diagram showing an example operation in which the image forming apparatus 2a acquires apparatus information D20 from the image forming apparatus 2b. The user connects the storage device 6 to the image forming apparatus 2a and instructs, via the operation panel 10 of the image forming apparatus 2a, to update the pattern file 25. Based on a user instruction to update the pattern file 25, the image forming apparatus 2a starts a process for updating the pattern file 25. Then, the image forming apparatus 2a transmits a request D10 to another image forming apparatus 2b via the network 3. Upon receiving the request D10, the image forming apparatus 2b generates apparatus information D20 regarding the image forming apparatus 2b and transmits the apparatus information D20 to the image forming apparatus 2a.

The apparatus information D20 includes setting information 27, status information 35, version information 36, and installation location information 37 of the image forming apparatus 2b. The setting information 27 is information indicating whether a confidential-information holding function, a data transmission/reception function, and a shared folder function of the image forming apparatus 2b are enabled or disabled. The status information 35 indicates whether the image forming apparatus 2b is in any of a "job executing" state, a "standby" state, or an "error-stopped" state. The version information 36 indicates a version of the pattern file 25 stored in the storage section 23 of the image forming apparatus 2b. The installation location information 37 is information indicating an installation location of the image forming apparatus 2b in the office environment 1, and includes information that can specify a floor or a room. Such installation location information 37 may be stored in advance in the storage section 23 of each image forming apparatus 2.

The update unit 33 acquires apparatus information D20 from each of the image forming apparatuses 2 connected to the network 3. Then, based on apparatus information D20 acquired from a plurality of image forming apparatuses 2 including the image forming apparatus itself and other image forming apparatuses 2, the update unit 33 selects, from among the plurality of image forming apparatuses 2, at least one image forming apparatus 2 for which the pattern file 25 is to be preferentially updated. Hereinafter, an image forming apparatus 2 for which the pattern file 25 should be preferentially updated may be referred to as a "priority apparatus".

When the update unit 33 selects an image forming apparatus 2 for which the pattern file 25 is to be preferentially updated, the update unit 33 notifies a user of the selected image forming apparatus 2. For example, the update unit 33 notifies the user by displaying the selected image forming apparatus 2 on the display part 10a of the operation panel 10. With this notification, the user can identify, among the plurality of image forming apparatuses 2 connected to the network 3, a priority apparatus for which the pattern file 25 should be preferentially updated. Accordingly, the user can move from the installation location of an image forming apparatus 2 whose pattern file 25 is currently being updated to the installation location of the priority apparatus, and can preferentially update the pattern file 25 stored in the priority apparatus.

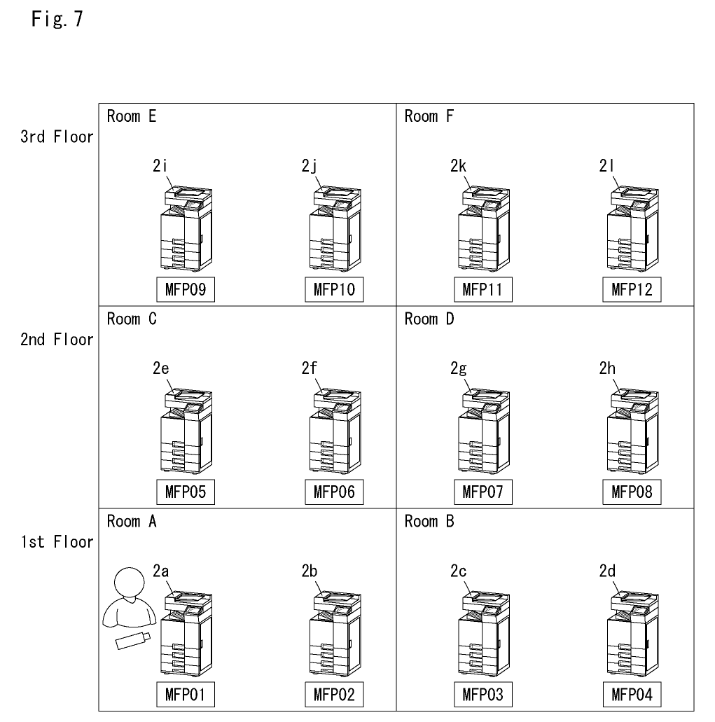

FIG. 7 is a diagram illustrating installation locations of a plurality of image forming apparatuses 2a-2l in the office environment 1. The office environment 1 includes rooms A and B on the first floor, rooms C and D on the second floor, and rooms E and F on the third floor. Two of the plurality of image forming apparatuses 2a to 2l are installed in each room. That is, in the example shown in FIG. 7, a total of twelve image forming apparatuses 2 are installed in the office environment 1. Hereinafter, the operation performed by the controller 20 will be described with reference to the image forming apparatuses 2 (2a to 2l) installed in such an office environment 1 as examples.

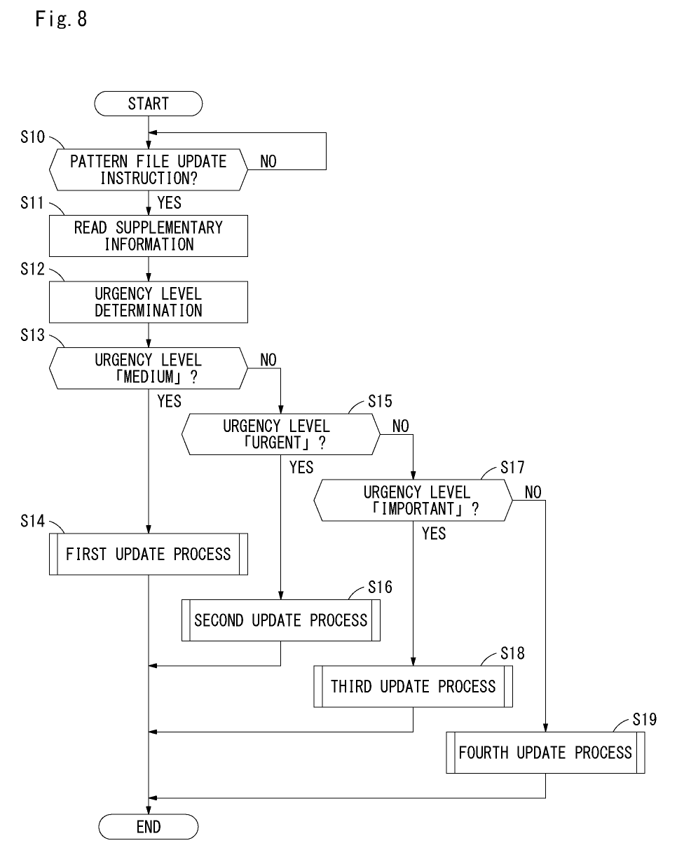

FIG. 8 is a flowchart illustrating a main processing procedure performed by the controller 20 of the image forming apparatus 2. This process is mainly performed by the update unit 33 in the controller 20. When the controller 20 starts the process shown in FIG. 8, the controller 20 waits until an instruction from a user to update the pattern file 25 is detected (step S10). When an update instruction is detected (YES in step S10), the controller 20 reads the supplementary information 26 from the storage device 6 (step S11) and determines the urgency level (step S12).

Based on the determination result, the controller 20 determines whether the urgency level is "medium" (step S13). If the urgency level is "medium" (YES in step S13), the controller 20 executes a first update process (step S14).

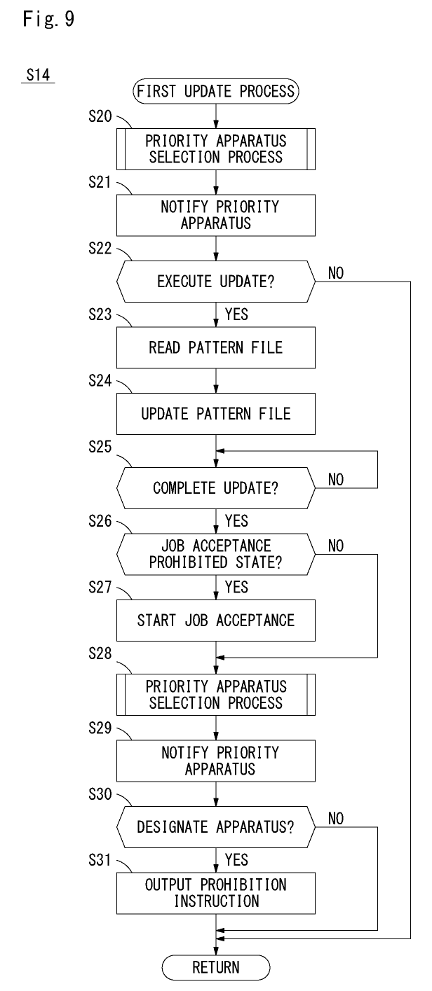

FIG. 9 is a flowchart illustrating details of a first update process executed when the urgency level is "medium". When the controller 20 starts the first update process, it executes a priority apparatus selection process (step S20). The priority apparatus selection process is a process of acquiring apparatus information D20 from other image forming apparatuses 2 and selecting, from among a plurality of image forming apparatuses 2 connected to the network 3, a priority apparatus for which the pattern file 25 is to be preferentially updated.

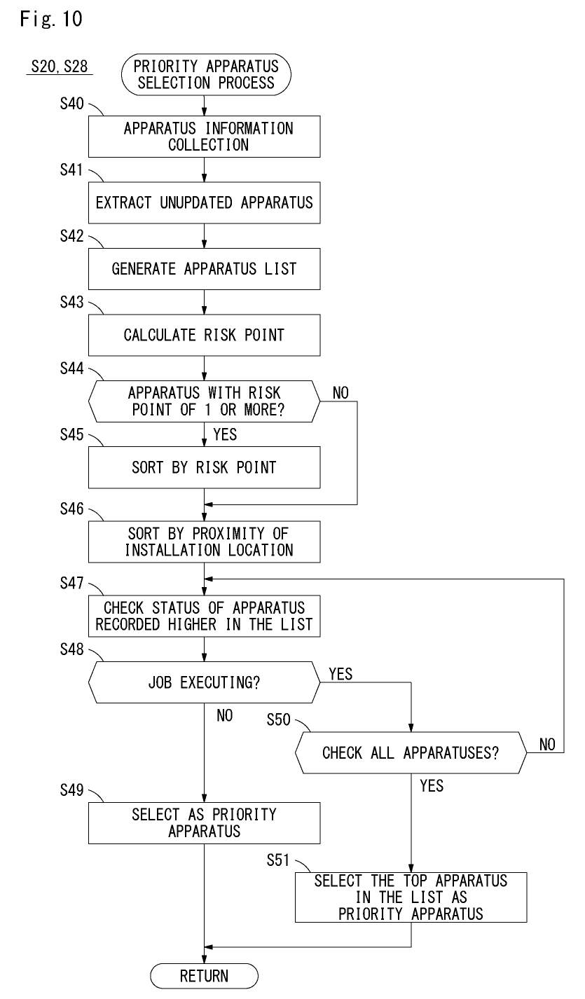

FIG. 10 is a flowchart showing details of the priority apparatus selection process. Upon starting the priority apparatus selection process, the controller 20 collects apparatus information D20 from a plurality of image forming apparatuses 2 connected to the network 3 (step S40). Specifically, the controller 20 transmits a request D10 to other image forming apparatuses 2 via the network 3, and acquires apparatus information D20 from the other image forming apparatuses 2. The controller 20 also acquires apparatus information D20 of its own apparatus.

After acquiring apparatus information D20 from all of the plurality of image forming apparatuses 2, the controller 20 compares version information of supplementary information 26 with version information 36 of the apparatus information D20, and extracts one or more image forming apparatuses 2 in which the pattern file 25 has not been updated (step S41). Then, the controller 20 creates an apparatus list of one or more image forming apparatus 2 for which the pattern file 25 has not been updated (step S42).

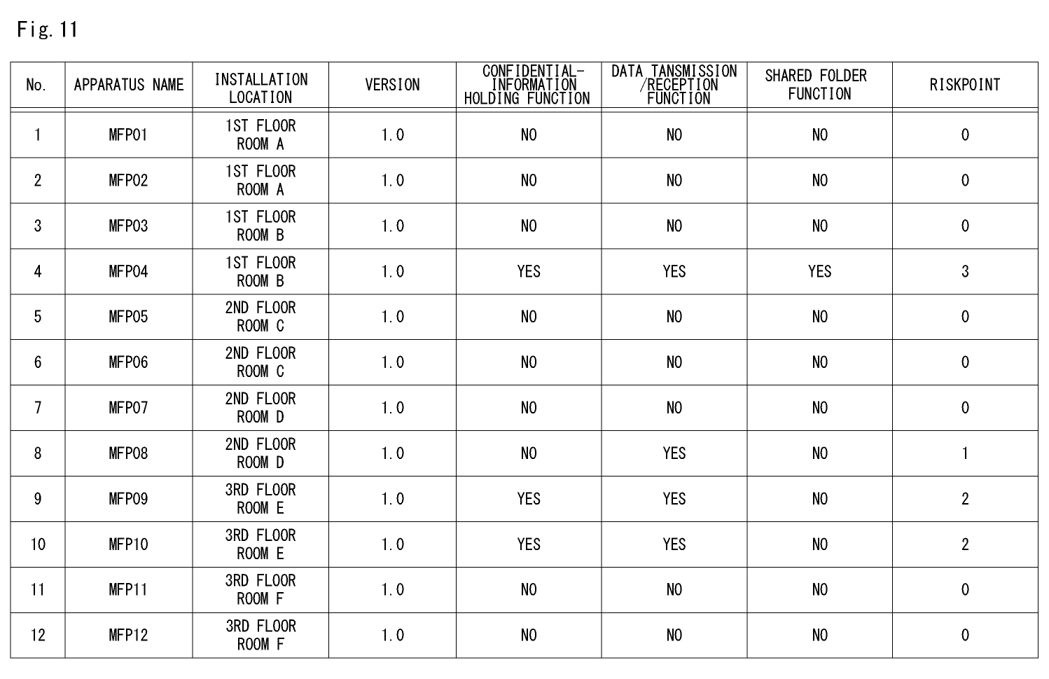

FIG. 11 is a diagram illustrating an example of the apparatus list. The apparatus list illustrated in FIG. 11 includes information on twelve images forming apparatuses 2a to 2l. Specifically, the apparatus list includes, for each of the image forming apparatuses 2a to 2l, an apparatus name, an installation location, a version, a confidential-information holding function, a data transmission/reception function, a shared folder function, and a risk point. Such an apparatus list is created based on setting information 27, version information 36, installation location information 37, and the like included in apparatus information D20. At the time the apparatus list is created, the risk point field is blank.

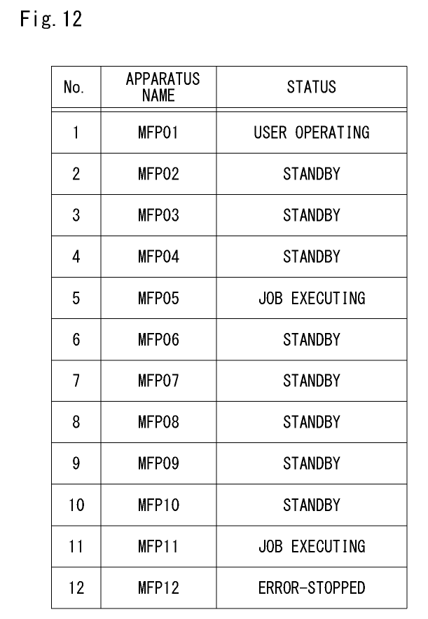

Further, when creating the apparatus list, the controller 20 creates a status list of the image forming apparatuses 2 for which the pattern file 25 has not been updated. FIG. 12 illustrates an example of the status list. The status list is information in which the status of each of the image forming apparatuses 2a to 2l is recorded. For example, the status list is created based on status information 35 included in apparatus information D20.

Referring back to FIG. 10. After creating the apparatus list, the controller 20 calculates a risk point (step S43). The risk point is a point value indicating a risk such as spread of infection or leakage of confidential information in the case of a virus infection, and a higher point value indicates a greater risk. For example, when the confidential-information holding function is enabled, if the image forming apparatus 2 is infected with a virus, confidential information 29 stored in the folder 28 may be leaked to the outside of the image forming apparatus 2. In addition, when the data transmission/reception function is enabled, if the image forming apparatus 2 is infected with a virus, the virus may be spread to other apparatuses, thereby causing the virus infection to spread. Further, when the shared folder function is enabled, confidential information 29 may be leaked or a virus infection may spread.

Therefore, if any one of the confidential-information holding function, the data transmission/reception function, and the shared folder function is enabled, the controller 20 calculates the risk point as "1". If the two functions are enabled, the controller 20 calculates the risk point as "2". Further, if the three functions are enabled, the controller 20 calculates the risk point as "3". Then, the controller 20 records, in the risk point column of the apparatus list, the risk point calculated for each image forming apparatus 2a to 2l. As a result, the apparatus list shown in FIG. 11 is obtained.

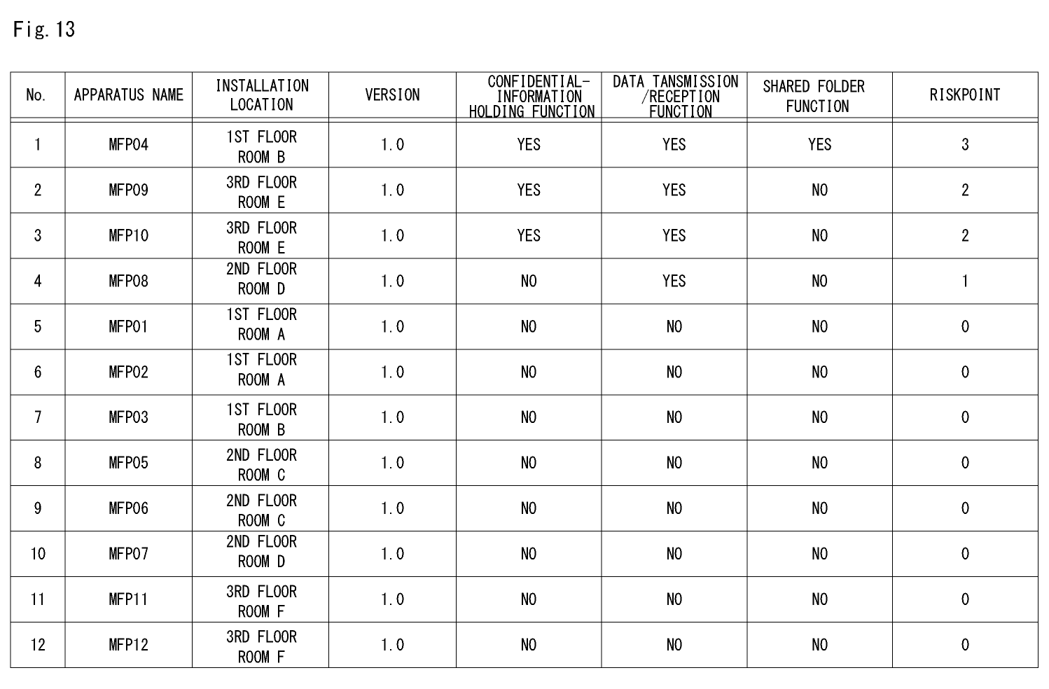

Next, the controller 20 determines whether there exists an image forming apparatus 2 having a risk point of 1 or more (step S44). If there exists an image forming apparatus 2 having a risk point of 1 or more (YES in step S44), the controller 20 sorts the apparatus list in descending order of risk point (step S45). As a result, the apparatus list shown in FIG. 11 is rearranged as shown in FIG. 13. In the apparatus list shown in FIG. 13, the image forming apparatus 2 having a high-risk point is recorded higher in the list.

Next, when a plurality of image forming apparatuses 2 having the same risk point exist in the apparatus list, the controller 20 sorts the plurality of image forming apparatuses 2 in ascending order of proximity of their installation locations (step S46). For example, the controller 20 sorts the apparatus list in ascending order of proximity of the installation locations to the image forming apparatus 2 currently being operated by the user. If a plurality of image forming apparatuses 2 having the same risk point do not exist in the apparatus list, the controller 20 may skip the processing in step S46.

Next, the controller 20 refers to the status list and checks the status of the image forming apparatus 2 recorded higher in the apparatus list (step S47). At this time, the controller 20 checks the status of the image forming apparatus 2 recorded at the top of the apparatus list. Then, the controller 20 determines whether the status of the image forming apparatus 2 indicates that a job is being executed (step S48). If the status of the image forming apparatus 2 indicates that no job is being executed (NO in step S48), the controller 20 selects the image forming apparatus 2, whose status was checked in step S47, as a priority apparatus (step S49).

On the other hand, if the status of the image forming apparatus 2 indicates that a job is being executed (YES in step S48), the controller 20 determines whether the statuses of all image forming apparatuses 2 recorded in the apparatus list have been checked (step S50). If the statuses of all image forming apparatuses 2 have not been checked (NO in step S50), the processing by the controller 20 returns to step S47. The controller 20 checks the status of the image forming apparatus 2 ranked next in the apparatus list (step S47). The controller 20 performs status checking processing for each of the plurality of image forming apparatus 2 one by one in descending order of risk point, and if the controller 20 detects an image forming apparatus 2 that is not executing a job, selects the detected image forming apparatus 2 as a priority apparatus (step S49).

The controller 20 may be unable to detect, from among all image forming apparatuses 2 recorded in the apparatus list, an image forming apparatus 2 that is not executing a job. In this case (YES in step S50), the controller 20 selects, as the priority apparatus, the image forming apparatus 2 at the top of the apparatus list (step S51). Thus, the priority apparatus selection process is completed.

The process returns to the flowchart of FIG. 9. When the controller 20 selects a priority apparatus for which the pattern file 25 is to be preferentially updated, the controller 20 notifies the user of the priority apparatus (step S21). For example, as illustrated in FIG. 7, when the user attempts to update the pattern file 25 of the image forming apparatus 2a installed in room A on the first floor, the controller 20 of the image forming apparatus 2a selects, as the priority apparatus, the image forming apparatus 2d installed in room B on the first floor. The controller 20 displays, on the pattern file update screen displayed on the display part 10a of the image forming apparatus 2a, a message indicating the priority apparatus.

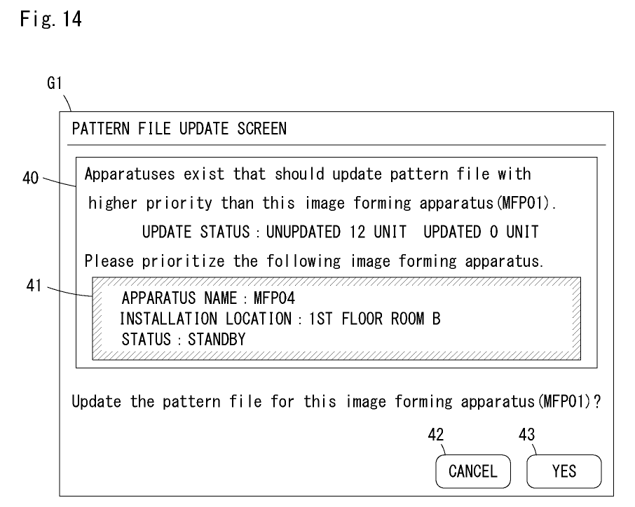

FIG. 14 is a diagram illustrating an example of a pattern file update screen G1 displayed on the image forming apparatus 2a. Upon detecting a pattern file update instruction from the user, the controller 20 displays, on the display part 10a, a pattern file update screen G1 as illustrated in FIG. 14. The pattern file update screen G1 includes a notification field 40 for notifying the user of the priority apparatus. When the controller 20 selects, as the priority apparatus, an image forming apparatus 2d different from the image forming apparatus 2a that the user is operating, the controller 20 displays the priority apparatus in the notification field 40. At this time, as illustrated in FIG. 14, the controller 20 displays detailed information 41 regarding the priority apparatus in the notification field 40. The detailed information 41 includes an installation location of the priority apparatus. Accordingly, the user can promptly move to the installation location of the image forming apparatus 2d for which the pattern file 25 is to be updated with priority.

Also, the pattern file update screen G1 includes operation buttons 42 and 43 operable by the user. The operation button 42 is a button for canceling the update of the pattern file 25 for the image forming apparatus 2a. When the user attempts to move in order to update, with priority, the pattern file 25 of the priority apparatus, the user operates the operation button 42 to cancel updating of the pattern file 25 in the image forming apparatus 2a. The operation button 43 is a button for instructing execution of an update of the pattern file 25 in the image forming apparatus 2a. The user can cause the image forming apparatus 2a to start a process of updating the pattern file 25 by operating the operation button 43.

After notifying the user of the priority apparatus, the controller 20 determines whether the user has instructed that updating of the pattern file 25 be executed (step S22). For example, when the user operates the operation button 42 to cancel updating of the pattern file 25 in the image forming apparatus 2a (NO in step S22), the processing performed by the controller 20 ends. The user then moves to the installation location of the image forming apparatus 2d selected as the priority apparatus.

When the user moves to the installation location of the image forming apparatus 2d selected as the priority apparatus, the user connects the storage device 6 to the image forming apparatus 2d and issues an instruction to update the pattern file 25. Then, processing similar to that described above is performed in the image forming apparatus 2d. As a result, the controller 20 of the image forming apparatus 2d selects its own apparatus as the priority apparatus and notifies the user of the selected priority apparatus.

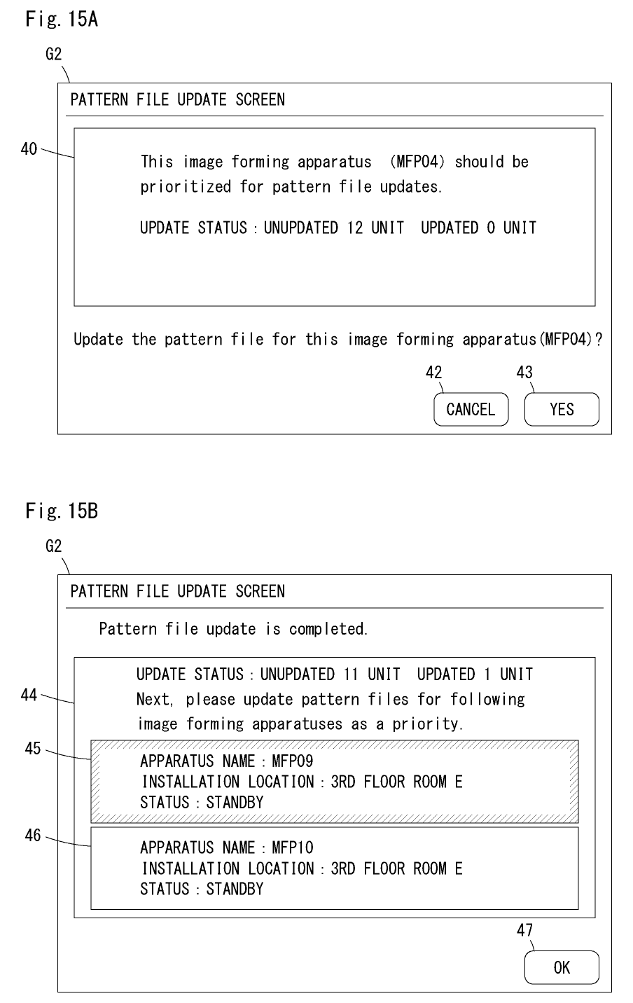

FIGS. 15A and 15B are diagrams showing an example of a pattern file update screen G2 displayed on the image forming apparatus 2d. When the controller 20 of the image forming apparatus 2d selects its own apparatus as the priority apparatus, the controller 20 displays a pattern file update screen G2 as shown in FIG. 15A. In the notification field 40 of the pattern file update screen G2, a message indicating that the apparatus itself is the priority apparatus is displayed. Therefore, the user operates the operation button 43 to cause the image forming apparatus 2d to start a process of updating the pattern file 25.

Upon detecting an instruction to execute the pattern file 25 (YES in step S22), the controller 20 reads the pattern file 25 from the storage device 6 (step S23). Then, the controller 20 initiates processing to update the pattern file 25 stored in the storage section 23 using the pattern file 25 read from the storage device 6 (step S24). Updating the pattern file 25 requires a certain amount of time. Accordingly, the controller 20 waits until the update processing of the pattern file 25 is completed (step S25).

When the processing of updating the pattern file 25 is completed (YES in step S25), the controller 20 determines whether job acceptance is in a prohibited state (step S26). When acceptance of jobs is in a prohibited state (YES in step S26), in response to completion of update processing of the pattern file 25, the controller 20 cancels the prohibited state and starts accepting jobs (step S27). Note that if job acceptance is not in a prohibited state (NO in step S26), the processing in step S27 is skipped.

Next, the controller 20 executes the priority apparatus selection process again (step S28). The detailed processing procedure of step S28 is the same as that in the flowchart of FIG. 10. At this time, the pattern file 25 of the image forming apparatus 2d has been updated to the latest version. Accordingly, from among the plurality of image forming apparatuses 2 other than the image forming apparatus 2d, the controller 20 selects, as a priority apparatus, an image forming apparatus 2 whose pattern file 25 is to be updated next on a priority basis.

For example, in the apparatus list of FIG. 13, after the pattern file 25 of the image forming apparatus 2d having the apparatus name "MFP04" is updated, the image forming apparatus 2i having the apparatus name "MFP09" is selected as the priority apparatus. In addition, the risk point of the image forming apparatus 2i having the apparatus name "MFP09" and the image forming apparatus 2j having the apparatus name "MFP10" is the same. Accordingly, the controller 20 may select, as priority apparatuses, two image forming apparatuses 2i and 2j having the same risk point.

Then, when the controller 20 selects the priority apparatus for which the pattern file 25 is to be updated next, the controller 20 notifies the user of the priority apparatus. At this time, the controller 20 displays, on the display part 10a, a pattern file update screen G2 as shown in FIG. 15B. A pattern file update screen G2 shown in FIG. 15B includes a notification field 44 for notifying the user of a next priority apparatus. When an image forming apparatus 2 different from the image forming apparatus 2d being operated by the user is selected as the next priority apparatus, the controller 20 displays the next priority apparatus in the notification field 44. The notification field 44 shown in FIG. 15B indicates that two image forming apparatuses 2i and 2j are priority apparatuses. That is, the controller 20 displays, in the notification field 44, detailed information 45 and 46 for the two image forming apparatuses 2i and 2j, respectively. When a plurality of image forming apparatuses 2i and 2j are displayed in the notification field 44, the user can designate, from among the plurality of image forming apparatuses 2i and 2j, an apparatus whose pattern file 25 is to be updated next. FIG. 15B shows an example in which the user designates the image forming apparatus 2i having an apparatus name "MFP09". Then, by operating the operation button 47, the user confirms the image forming apparatus 2 whose pattern file 25 is to be updated next.

After notifying the user of the priority apparatus, the controller 20 determines whether the image forming apparatus 2 whose pattern file 25 is to be updated next has been designated by the user (step S30). When the image forming apparatus 2 that is to have its pattern file 25 updated next is designated (YES in step S30), the controller 20 outputs, to the image forming apparatus 2 designated by the user, a prohibition instruction prohibiting acceptance of a job (step S31). The image forming apparatus 2 that has received the prohibition instruction enters a prohibited state in which acceptance of a job is prohibited. For example, when the user moves to the installation location of the image forming apparatus 2, if the image forming apparatus 2 is executing a job, the pattern file 25 cannot be updated. Accordingly, the controller 20 can prevent the status of the image forming apparatus 2 from changing while the user is moving by outputting a prohibition instruction to the next image forming apparatus 2. When the user does not designate the image forming apparatus 2 for updating the next pattern file 25 (NO in step S30), the processing of step S31 is skipped. Thus, the first update process (step S14) in the case where the urgency level is "medium" is completed.

As described above, when the urgency level is "medium", before acquiring the pattern file 25 from the storage device 6, the image forming apparatus 2 preferentially selects, from among a plurality of image forming apparatuses 2 including itself and other image forming apparatuses 2, an image forming apparatus 2 whose pattern file 25 is to be updated. The image forming apparatus 2 notifies the user of the image forming apparatus 2 selected as the priority apparatus. Accordingly, before updating the pattern file 25 of the image forming apparatus 2 currently in operation, the user can recognize the image forming apparatus 2 whose pattern file 25 is to be updated with priority.

After acquiring the pattern file 25 from the storage device 6, the image forming apparatus 2 selects, from among other image forming apparatuses 2 connected to the network 3 excluding itself, an image forming apparatus 2 whose pattern file 25 is to be updated next on a priority basis. The image forming apparatus 2 notifies the user of the image forming apparatus 2 selected next as a priority apparatus. Accordingly, after updating the pattern file 25 of one image forming apparatus 2, the user can recognize the image forming apparatus 2 whose pattern file 25 is to be preferentially updated next. Accordingly, when updating the pattern file 25 held in each of the plurality of image forming apparatuses 2, the user can update the pattern files 25 sequentially, starting with the image forming apparatus 2 having the highest priority.

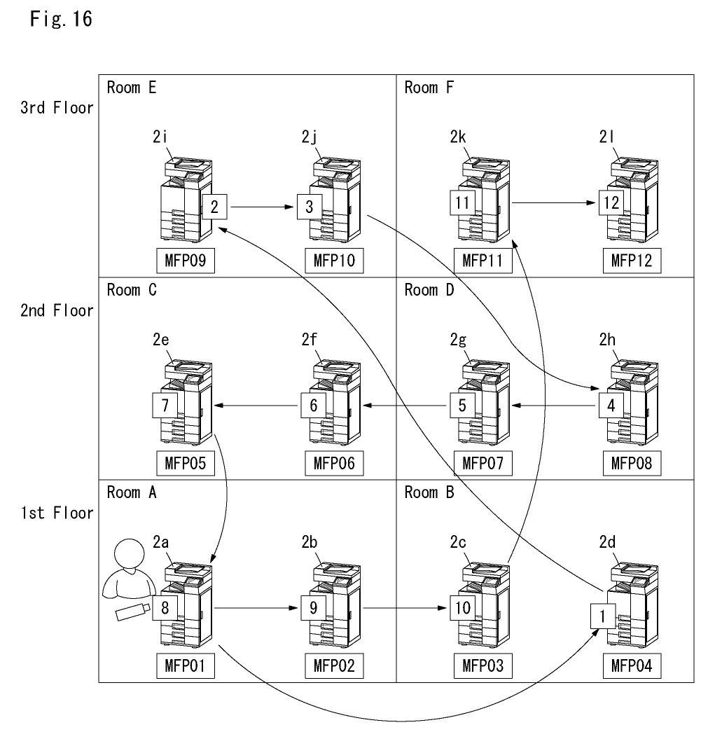

FIG. 16 is a diagram illustrating an order in which a user updates the pattern file 25 when the urgency level is "medium". When the user first connects the storage device 6 to the image forming apparatus 2a and issues a pattern file update instruction, the user is notified that the image forming apparatus 2d is the priority apparatus. Accordingly, the user moves to the installation location of the image forming apparatus 2d and issues a pattern file update instruction to the image forming apparatus 2d. The image forming apparatus 2d updates the pattern file 25 based on an instruction from the user to select itself as a priority apparatus. Thereafter, the image forming apparatus 2d notifies the user that the image forming apparatus 2i is the next priority apparatus. Based on the notification, the user moves to an installation location of the image forming apparatus 2i and issues an instruction to update a pattern file to the image forming apparatus 2i. The image forming apparatus 2i, in order to select itself as a priority apparatus, updates the pattern file 25 based on an instruction from the user. Thereafter, the image forming apparatus 2i notifies the user that the image forming apparatus 2j is the next priority apparatus.

Accordingly, the user can move within the office environment 1 based on a notification from the image forming apparatus 2 and sequentially update the pattern file 25 of the image forming apparatus 2 selected as a priority image forming apparatus. As a result, the pattern file 25 is updated in descending order of risk point of the image forming apparatuses 2. As a result, the user can update the pattern files 25 of a plurality of image forming apparatus 2 in an optimal order. In FIG. 16, the numerals assigned to the image forming apparatus 2a to 2l indicate the order in which the pattern file 25 is updated.

Return to the flowchart of FIG. 8. If the urgency level is not "medium" (NO in step S13), the controller 20 determines whether the urgency level is "urgent" (step S15). If the urgency level is "urgent" (YES in step S15), the controller 20 executes a second update process (step S16).

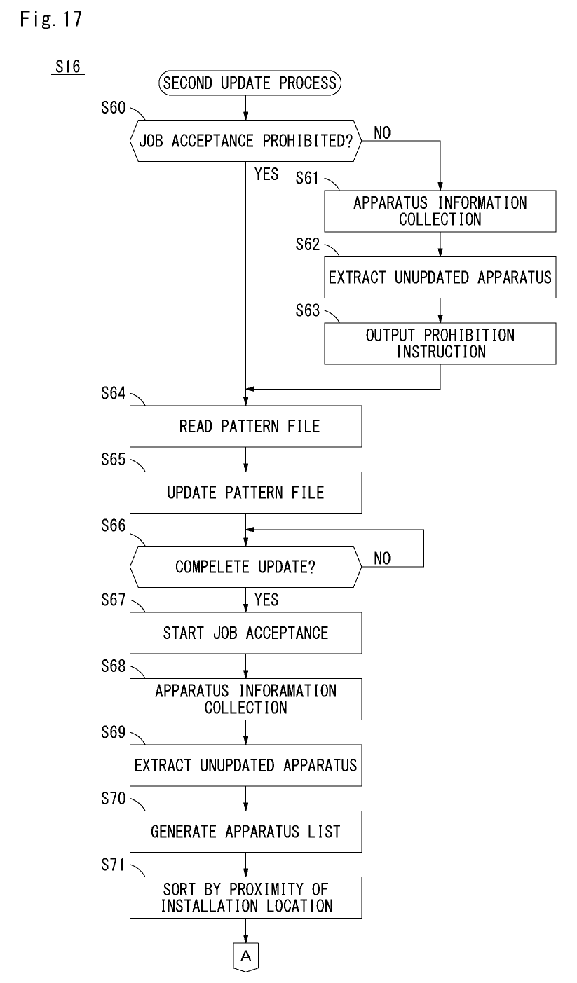

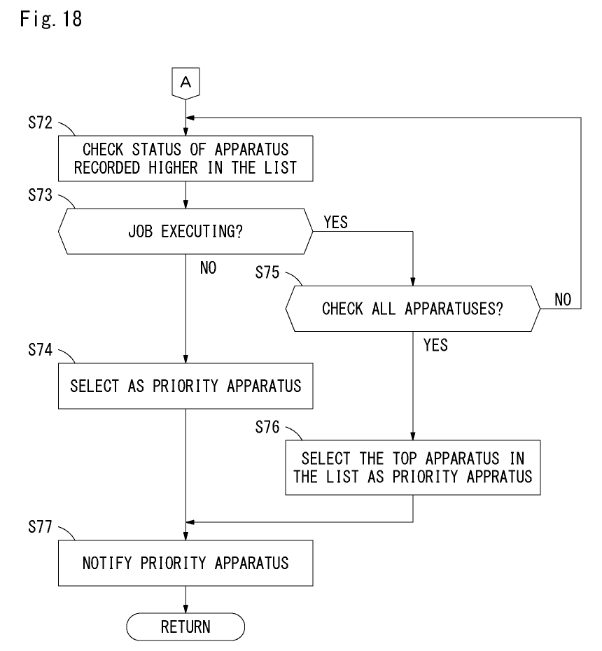

FIGS. 17 and 18 are flowcharts showing details of the second update process that is executed when the urgency level is "urgent". Upon starting the second update process, the controller 20 determines whether job acceptance is in a prohibited state (step S60). If job acceptance is not prohibited (NO in step S60), the controller 20 collects apparatus information D20 from a plurality of image forming apparatuses 2 connected to the network 3 (step S61).

After acquiring the apparatus information D20 from all of the plurality of image forming apparatuses 2, the controller 20 compares version information of supplementary information 26 with version information 36 of the apparatus information D20, and extracts image forming apparatuses 2 in which the pattern file 25 is not updated (step S62). Then, the controller 20 outputs, to the image forming apparatuses 2 for which the pattern file 25 has not been updated, a prohibition instruction prohibiting acceptance of a job (step S63). As a result, all image forming apparatuses 2 whose pattern files 25 have not been updated enter a prohibited state in which job acceptance is prohibited. The controller 20 also prohibits the apparatus itself from accepting a job.

If job acceptance is already prohibited at the time the second update process is started (YES in step S60), the processes of steps S61 to S63 are not performed.

Next, the controller 20 reads the pattern file 25 from the storage device 6 (step S64). Then, the controller 20 starts a process of updating the pattern file 25 stored in the storage section 23 using the pattern file 25 read from the storage device 6 (step S65). The controller 20 waits until the process of updating the pattern file 25 is completed (step S66).

When the process of updating the pattern file 25 is completed (YES in step S66), the controller 20 cancels the job-reception prohibition state and starts receiving jobs (step S67).

Next, the controller 20 collects apparatus information D20 from the plurality of image forming apparatuses 2 connected to the network 3 (step S68). After acquiring apparatus information D20 from each of the plurality of image forming apparatuses 2, the controller 20 compares version information of supplementary information 26 with version information 36 of the apparatus information D20, and extracts image forming apparatuses 2 for which the pattern file 25 has not been updated (step S69). Then, the controller 20 generates an apparatus list of image forming apparatus 2 for which the pattern file 25 has not been updated (step S70). At this time, a status list of the image forming apparatus 2 for which the pattern file 25 has not been updated is also created.

After creating the apparatus list, the controller 20 sorts the image forming apparatuses 2 included in the apparatus list in ascending order of proximity of their installation locations. For example, the controller 20 sorts the apparatus list in ascending order of proximity of the installation locations to the image forming apparatus 2 currently being operated by the user. Then, the process proceeds to the flowchart of FIG. 18.

Next, the controller 20 refers to the status list and checks the status of the image forming apparatus 2 listed higher in the apparatus list sorted based on the installation location (step S72). At this time, the controller 20 checks the status of the image forming apparatus 2 recorded at the top of the apparatus list. Then, the controller 20 determines whether the status of the image forming apparatus 2 indicates that a job is being executed (step S73). If the status of the image forming apparatus 2 indicates that no job is being executed (NO in step S73), the controller 20 selects, as the next priority apparatus, the image forming apparatus 2 whose status was confirmed in step S72 (step S74).

On the other hand, when the status of the image forming apparatus 2 indicates "job in execution" (YES in step S73), the controller 20 determines whether the statuses of all the image forming apparatuses 2 recorded in the apparatus list have been checked (step S75). If the statuses of all the image forming apparatuses 2 have not all been checked (NO in step S75), processing by the controller 20 returns to step S72. The controller 20 checks the status of the image forming apparatus 2 ranked next in the apparatus list (step S72). The controller 20 executes status confirmation processing on the plurality of image forming apparatuses 2 one by one in ascending order of proximity of the installation location, and, if the controller 20 detects an image forming apparatus 2 that is not executing a job, the controller 20 selects the detected image forming apparatus 2 as the next-priority apparatus (step S74).

The controller 20 may be unable to detect, from among all the image forming apparatuses 2 recorded in the apparatus list, an image forming apparatus 2 that is not executing a job. In this case (YES in step S75), the controller 20 selects the image forming apparatus 2 at the top of the apparatus list as the next priority apparatus (step S76).

When the controller 20 selects the next priority apparatus, the controller 20 notifies the user of the next priority apparatus (step S77). In this case, for example, a pattern file update screen G2 as illustrated in FIG. 15B is displayed on the display part 10a of the operation panel 10. Based on a notification from the image forming apparatus 2, the user can identify the image forming apparatus 2 whose pattern file 25 is to be updated next. Then, the user can promptly move to the installation location of the image forming apparatus 2 whose pattern file 25 is to be updated next, and update the pattern file 25. Thus, the second update process (step S16) is completed when the urgency level is "urgent".

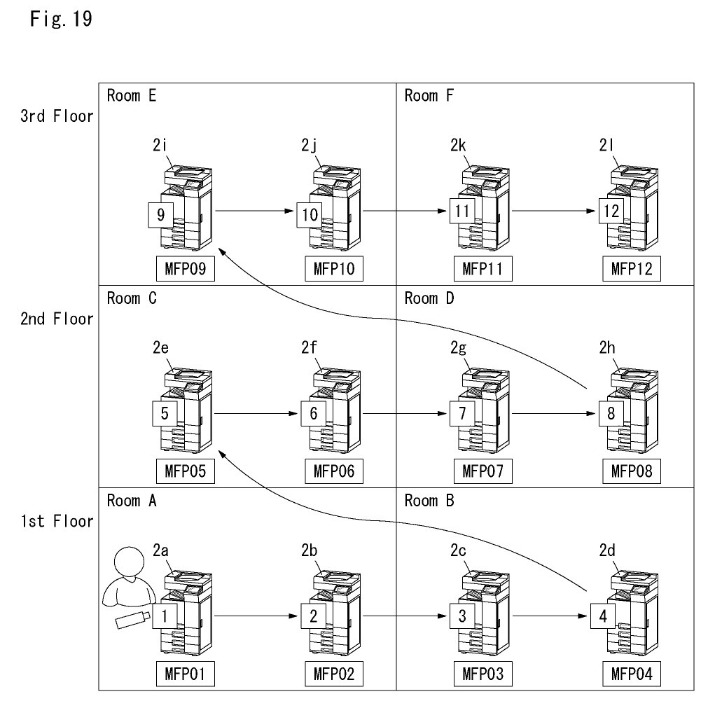

FIG. 19 is a diagram illustrating an order in which a user updates the pattern file 25 when the urgency level is "urgent". When the user first connects the storage device 6 to the image forming apparatus 2a and issues an instruction to update the pattern file 25, the image forming apparatus 2a outputs a prohibition instruction to the other image forming apparatuses 2b to 2l. As a result, the image forming apparatuses 2b to 2l enter a prohibited state in which job acceptance is prohibited. The image forming apparatus 2a also prohibits acceptance of a job by itself. The image forming apparatus 2a then updates its own pattern file 25. After the image forming apparatus 2a updates the pattern file 25, the image forming apparatus 2a starts accepting jobs. In addition, the image forming apparatus 2a selects, as a next-priority apparatus, the image forming apparatus 2b installed at a nearby location, and notifies the user thereof. Based on this notification, the user moves to the installation location of the image forming apparatus 2b and issues an instruction to update the pattern file 25.

The image forming apparatus 2b updates its own pattern file 25 while job acceptance is prohibited. After the image forming apparatus 2b updates the pattern file 25, the image forming apparatus 2b starts accepting its own jobs. In addition, the image forming apparatus 2b selects, as a next-priority apparatus, the image forming apparatus 2c installed at a nearby location, and notifies the user thereof. Based on this notification, the user moves to the installation location of the image forming apparatus 2c and issues an instruction to update the pattern file 25.

In this way, when the urgency level is "urgent", the image forming apparatuses 2 whose pattern files 25 have not been updated are prohibited from accepting jobs. The user can update the pattern files 25 of all of the image forming apparatus 2 in a short time by sequentially updating the pattern file 25 of each image forming apparatus 2, starting with the image forming apparatus 2 closest to the installation location, while job acceptance is prohibited in each image forming apparatus 2. In FIG. 19, the numbers assigned to the image forming apparatuses 2a to 2l indicate the order in which the pattern file 25 is updated.

The process returns to the flowchart of FIG. 8. If the urgency level is not "urgent" (NO in step S15), the controller 20 determines whether the urgency level is "important" (step S17). If the urgency level is "important" (YES in step S17), the controller 20 executes a third update process (step S18).

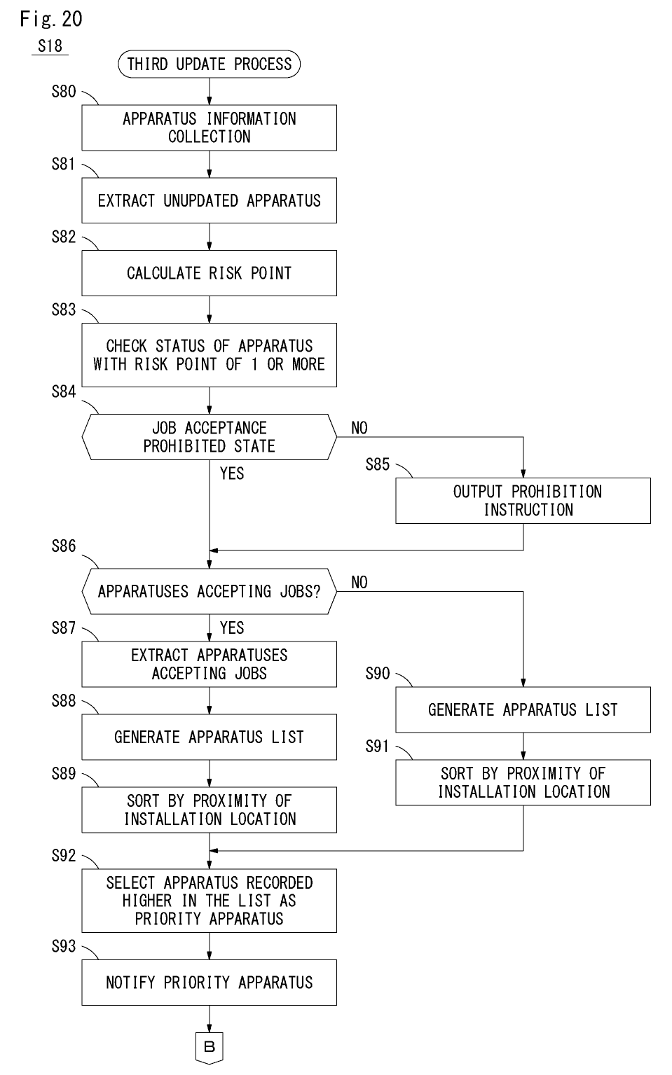

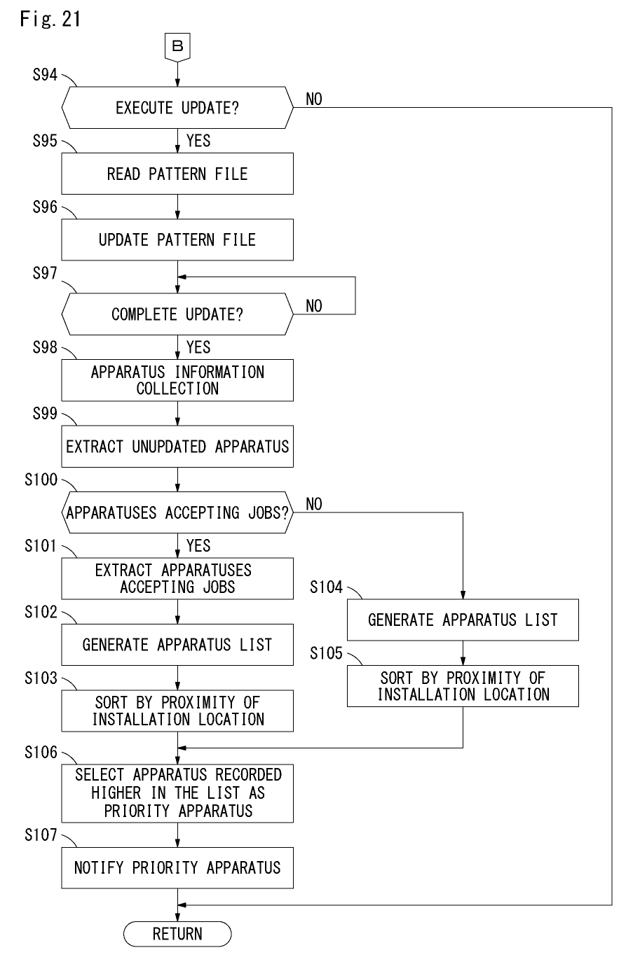

FIGS. 20 and 21 are flowcharts showing details of the third update process executed when the urgency level is "important". Upon starting the third update process, the controller 20 collects apparatus information D20 from the plurality of image forming apparatuses 2 connected to the network 3 (step S80).

After acquiring apparatus information D20 from all of a plurality of image forming apparatus 2, the controller 20 compares version information of supplementary information 26 with version information 36 in the apparatus information D20, and extracts an image forming apparatus 2 in which the pattern file 25 has not been updated (step S81). The controller 20 calculates a risk point for the image forming apparatus 2 in which the pattern file 25 has not been updated (step S82), and checks the status of the image forming apparatus 2 having a risk point of 1 or more (step S83). Then, the controller 20 determines whether the image forming apparatus 2 having a risk point of 1 or more is in a prohibited state in which job acceptance is prohibited (step S84). When job acceptance is prohibited in the image forming apparatus 2 having a risk point of 1 or more (YES in step S84), the processing by the controller 20 proceeds to step S86. In contrast, when the image forming apparatus 2 having a risk point of 1 or more is in a state capable of accepting the job (NO in step S84), the controller 20 outputs a prohibition instruction to the image forming apparatus 2 having a risk point of 1 or more (step S85). Accordingly, the image forming apparatuses 2 each having a risk point of 1 or more enter a prohibited state in which they are collectively prohibited from accepting jobs.

Next, the controller 20 determines whether there is an image forming apparatus 2 that can accept the job (step S86). That is, the controller 20 determines whether an image forming apparatus 2 having a risk point of less than 1 exists. If there is an image forming apparatus 2 capable of accepting the job (YES in step S86), the controller 20 extracts all such image forming apparatuses 2 (step S87). Then, the controller 20 creates an apparatus list of the extracted image forming apparatus 2 (step S88), and sorts the apparatus list in order of increasing proximity of the installation locations (step S89). For example, the controller 20 sorts the apparatus list in ascending order of proximity of the installation locations to the image forming apparatus 2 currently being operated by the user.

In contrast, when there is no image forming apparatus 2 that can accept the job (NO in step S86), the controller 20 creates an apparatus list of image forming apparatuses 2 for which job acceptance is prohibited (step S90). Then, the controller 20 sorts the apparatus list in ascending order of proximity of the installation locations (step S91). For example, the controller 20 sorts the apparatus list in ascending order of proximity of the installation locations to the image forming apparatus 2 currently being operated by the user.

Next, the controller 20 selects the image forming apparatus 2 at the top of the apparatus list as a priority apparatus (step S92), and notifies the user of the selected priority apparatus (step S93). At this time, the controller 20 may notify the user that the apparatus itself is a priority apparatus. Then, the process proceeds to the flowchart of FIG. 21.

The controller 20 determines whether the user has instructed that the pattern file 25 be updated (step S94). If the user cancels the update of the pattern file 25 (NO in step S94), the processing by the controller 20 ends. In contrast, if execution of the update of the pattern file 25 is instructed (YES in step S94), the controller 20 reads the pattern file 25 from the storage device 6 (step S95). Then, the controller 20 starts processing to update the pattern file 25 in the storage section 23 (step S96). Thereafter, the controller 20 waits until the update processing of the pattern file 25 is completed (step S97).

When the updating of the pattern file 25 is completed (YES in step S66), the controller 20 again collects apparatus information D20 from a plurality of image forming apparatuses 2 connected to the network 3 (step S98). Then, the controller 20 extracts the image forming apparatus 2 in which the pattern file 25 has not been updated (step S99). At this time, if the apparatus is in a job acceptance prohibited state, the controller 20 cancels the prohibited state and returns the apparatus to a job-acceptance-enabled state.

Then, the controller 20 executes the processing of steps S100 to S107. The processing of steps S100 to S107 is the same as the processing of steps S86 to S93 shown in FIG. 20. Accordingly, if there is an image forming apparatus 2 that can accept a job among the image forming apparatuses 2 whose pattern files 25 have not been updated, the controller 20 selects, as the next priority apparatus, the closest image forming apparatus 2 among them. When no image forming apparatus 2 is capable of accepting a job, the controller 20 selects, as the next priority apparatus, from among the image forming apparatuses 2 for which job acceptance is prohibited, the image forming apparatus 2 that is located at the closest position. Then, the controller 20 notifies the user of the selected priority apparatus. Thus, the third update process (step S18) in a case where the urgency level is "important" is completed.

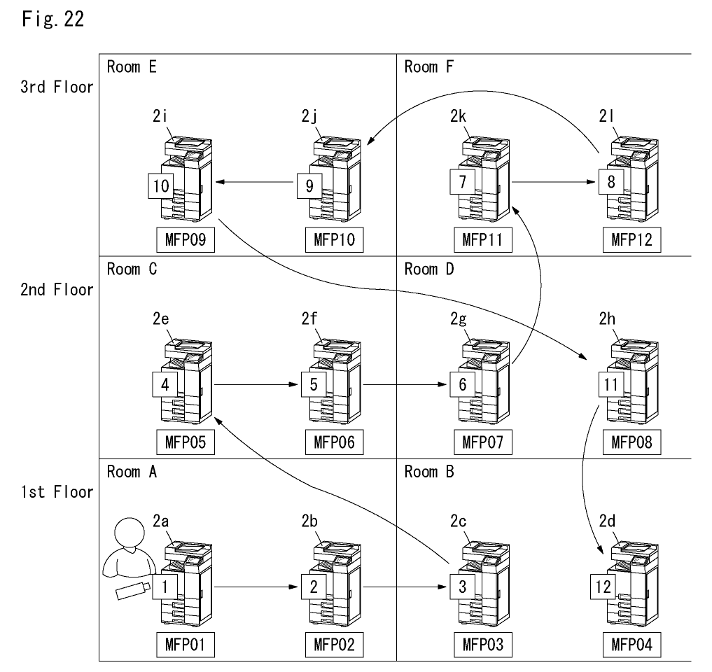

FIG. 22 is a diagram illustrating an update order of the pattern file 25 to be performed by a user when the urgency level is "important". When the user first connects the storage device 6 to the image forming apparatus 2a and issues an instruction to update the pattern file 25, the image forming apparatus 2a outputs a prohibition instruction to other image forming apparatuses 2d, 2h, 2i, and 2j each having a risk point of 1 or more. Accordingly, the image forming apparatuses 2d, 2h, 2i, and 2j enter a prohibited state in which job acceptance is prohibited, thereby eliminating a risk of virus infection. In this state, the user sequentially updates the pattern file 25 starting with an image forming apparatus 2 for which job acceptance is not prohibited. That is, when an image forming apparatus 2 that outputs the prohibition instruction and an image forming apparatus 2 that does not output the prohibition instruction coexist, the controller 20 increases a priority of the image forming apparatus 2 that does not output the prohibition instruction. Specifically, the controller 20 sets a priority of an image forming apparatus 2 that does not output a prohibition instruction to be higher than a priority of an image forming apparatus 2 that outputs the prohibition instruction. Then, the controller 20 selects a priority apparatus with a priority of the image forming apparatus 2 that does not output a prohibition instruction increased.

Finally, the user sequentially updates the pattern file 25 of the image forming apparatuses 2d, 2h, 2i, and 2j for which job acceptance is prohibited, and applies the latest version of the pattern file 25 to all image forming apparatuses 2. In FIG. 22, the numerals assigned to the image forming apparatuses 2a to 2l indicate the order in which the pattern file 25 is updated.

The process returns to the flowchart of FIG. 8. If the urgency level is not "urgent" (NO in step S17), the urgency level is set to "low". When the urgency level is "low", the controller 20 executes a fourth update process (step S19).

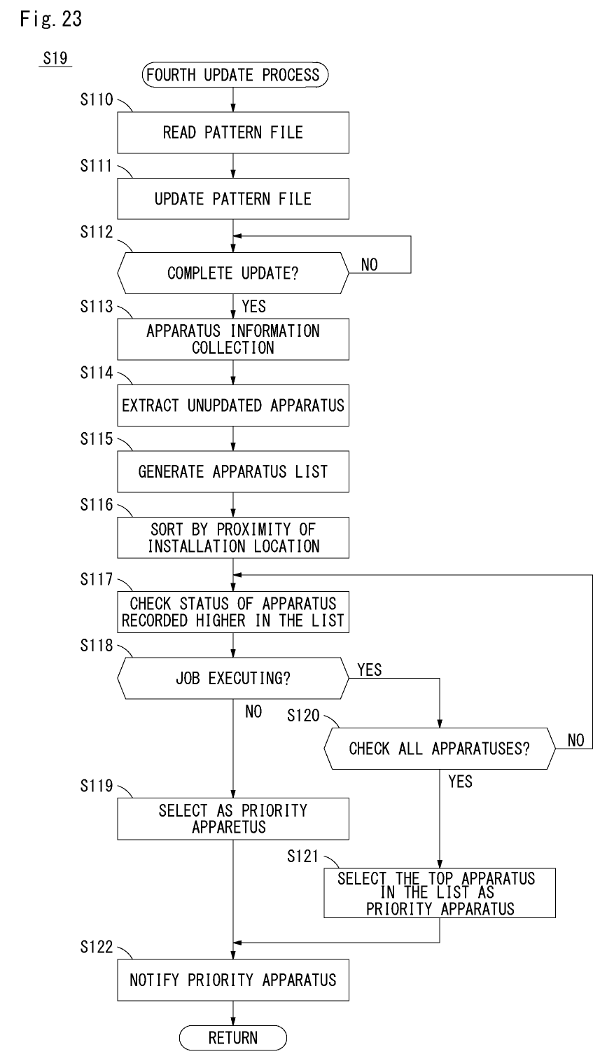

FIG. 23 is a flowchart illustrating details of the fourth update process executed when the urgency level is "low". Upon starting the fourth update process, the controller 20 reads the pattern file 25 from the storage device 6 (step S110) and starts updating the pattern file 25 stored in the storage section 23 (step S111). The controller 20 waits until the update process is completed (step S112).

When the update process of the pattern file 25 is completed (YES in step S112), the controller 20 collects apparatus information D20 from other image forming apparatuses 2 connected to the network 3 (step S113). Then, the controller 20 extracts image forming apparatuses 2 for which the pattern file 25 has not been updated (step S114) and creates an apparatus list of the extracted image forming apparatuses 2 (step S115). The controller 20 sorts the device list in ascending order of proximity of the installation location (step S116). That is, the controller 20 sorts the image forming apparatuses 2 included in the apparatus list in order of proximity to the image forming apparatus 2 currently being operated by the user.

Next, the controller 20 checks the status of the image forming apparatus 2 recorded higher in the apparatus list (step S117). Then, the controller 20 determines whether the status of the image forming apparatus 2 indicates that a job is being executed (step S118). If the status of the image forming apparatus 2 indicates that no job is being executed (NO in step S118), the controller 20 selects, as a priority apparatus, the image forming apparatus 2 whose status was confirmed in step S117 (step S119).

On the other hand, if the status of the image forming apparatus 2 indicates job being executed (YES in step S118), the controller 20 determines whether the statuses of all image forming apparatuses 2 recorded in the apparatus list have been checked (step S120). If the statuses of all image forming apparatuses 2 have not been checked (NO in step S120), processing by the controller 20 returns to step S117. Then, the controller 20 checks the status of the image forming apparatus 2 with the next-highest priority in the apparatus list (step S117). The controller 20 executes status confirmation processing, one apparatus at a time, in ascending order of proximity of installation location in the apparatus list, and, upon detecting an image forming apparatus 2 that is not executing a job, selects the detected image forming apparatus 2 as a priority apparatus (step S119).

Further, in some cases, the controller 20 may be unable to detect an image forming apparatus 2 that is not executing a job from among all the image forming apparatuses 2 recorded in the apparatus list. In this case (YES in step S120), the controller 20 selects the image forming apparatus 2 at the top of the apparatus list as the priority apparatus (step S121). Then, the controller 20 notifies the user of the priority apparatus selected in step S119 or S121 (step S122). Thus, the fourth update processing (step S19) ends when the urgency is "low".

When the urgency is "low", the order in which the user updates the pattern file 25 is the same as that in the case where the urgency is "urgent", as shown in FIG. 19. However, when the urgency is "urgent", while the user performs the update operation, the image forming apparatus 2 for which the pattern file 25 has not been updated is in a state in which acceptance of a job is prohibited. In contrast, when the urgency level is "low", an image forming apparatus 2 whose pattern file 25 has not been updated is in a state in which the image forming apparatus 2 is capable of accepting a job while the user performs an update operation.

As described above, the image forming apparatus 2 according to the present embodiment updates the pattern file 25 used for virus detection processing in an environment isolated from the external network 7. When updating the pattern file 25, the image forming apparatus 2 selects, from among a plurality of image forming apparatuses 2 including itself and other image forming apparatuses 2 connected to the network 3, an image forming apparatus 2 whose pattern file 25 is to be updated with priority, and notifies the user of the selected image forming apparatus 2. Accordingly, based on a notification from the image forming apparatus 2, the user can identify, among the plurality of image forming apparatuses 2 connected to the network 3, an image forming apparatus 2 for which the pattern file 25 is to be updated on a priority basis.

Further, before acquiring the pattern file 25 from the storage device 6, the image forming apparatus 2 selects, from among a plurality of image forming apparatuses 2 including itself and other image forming apparatuses 2, an image forming apparatus 2 for which the pattern file 25 is to be updated on a priority basis. Accordingly, the image forming apparatus 2 can notify the user of the apparatus to be prioritized before starting the update of the pattern file 25.

After acquiring the pattern file 25 from the storage device 6, the image forming apparatus 2 selects, from among other image forming apparatuses 2 connected to the network 3, an image forming apparatus 2 for which the pattern file 25 is to be updated next on a priority basis. Accordingly, after updating the pattern file 25 of the image forming apparatus 2, the user can identify the image forming apparatus 2 whose pattern file 25 is to be updated next.

### Modification Example

Preferred embodiments of the present invention have been described above. However, the present invention is not limited to the matters described in the above embodiment, and various modifications may be made thereto.

For example, the storage device 6 described in the above embodiment is not limited to a USB flash memory. For example, the storage device 6 may be a portable terminal such as a smartphone or a tablet terminal. When the storage device 6 is a portable terminal, the portable terminal is communicatively connected to an image forming apparatus 2 whose pattern file 25 is to be updated, and the pattern file 25 stored in the portable terminal is read out from the portable terminal by the image forming apparatus 2. Accordingly, even when the storage device 6 is a portable terminal, the same operations as those described above can be performed.

Further, the information processing apparatus 4 connected to the network 3 may be used as the storage device 6. In this case, the information processing apparatus 4 launches a Web browser and sequentially accesses each of the plurality of image forming apparatuses 2 via the network 3. The information processing apparatus 4 then updates the pattern file 25 of each image forming apparatus 2 via the network 3. In this case, upon detecting an access from the information processing apparatus 4, the image forming apparatus 2 collects apparatus information D20 from the other image forming apparatuses 2 and selects a priority apparatus. The image forming apparatus 2 then displays the priority apparatus on a Web browser screen of the information processing apparatus 4. At this time, the image forming apparatus 2 displays, on a Web browser screen, an address (URL) for accessing the priority apparatus. Accordingly, while operating the information processing apparatus 4, the user can preferentially update the pattern file 25 of the priority apparatus notified by the image forming apparatus 2. In this case, since the user no longer needs to move within the office environment 1, work efficiency is improved.

In the above-described embodiment, a case has been exemplified in which the program 24 executed by the CPU 21 of the controller 20 is stored in advance in the storage section 23 of the image forming apparatus 2. However, the program 24 is not limited to a program that is installed in advance in the image forming apparatus 2. That is, the program 24 can independently be the subject of a transaction. Accordingly, the program 24 may be provided as recorded on a computer-readable recording medium such as a CD-ROM. Further, the program 24 may be provided in a downloadable form via a network such as the Internet.

Although embodiments of the present invention have been described and illustrated in detail, the disclosed embodiments are provided for purposes of illustration and example only and not limitation. The scope of the present invention should be construed in accordance with the terms of the appended claims.

What is claimed is:

1. An image forming apparatus that performs virus detection processing on data using a pattern file, comprising:
a storage section that stores the pattern file; and
a controller that updates the pattern file stored in the storage section, wherein
when updating the pattern file, the controller selects, on a priority basis, an image forming apparatus whose pattern file is to be updated preferentially from among a plurality of image forming apparatuses including another image forming apparatus connected to a network and the image forming apparatus itself, and notifies a user of the selected image forming apparatus.

2. The image forming apparatus according to claim 1, wherein
when updating the pattern file, the controller collects apparatus information regarding other image forming apparatuses and selects an image forming apparatus whose pattern file is to be updated preferentially based on the apparatus information.

3. The image forming apparatus according to claim 1, wherein
the controller acquires the pattern file from a storage device storing a latest version of the pattern file and updates the pattern file stored in the storage section.

4. The image forming apparatus according to claim 3, wherein
before acquiring the pattern file from the storage device, the controller selects, from among the plurality of image forming apparatuses including another image forming apparatus and the image forming apparatus itself, an image forming apparatus whose pattern file is to be updated on a priority basis.

5. The image forming apparatus of claim 3, wherein
after acquiring the pattern file from the storage device, the controller selects, from among other image forming apparatuses connected to the network, an image forming apparatus whose pattern file is to be updated next with priority.

6. The image forming apparatus of claim 2, wherein
the apparatus information includes information indicating whether a confidential-information holding function for retaining confidential information is enabled or disabled, and
the controller preferentially selects an image forming apparatus in which the confidential-information holding function is enabled, as an image forming apparatus whose pattern file is to be updated preferentially.

7. The image forming apparatus according to claim 2, wherein
the apparatus information includes information indicating whether a data transmission/reception function is enabled or disabled, and
the controller preferentially selects an image forming apparatus in which the data transmission/reception function is enabled, as an image forming apparatus whose pattern file is to be updated preferentially.

8. The image forming apparatus according to claim 2, wherein
the apparatus information includes information indicating whether a shared folder function is enabled or disabled, and
the controller preferentially selects an image forming apparatus in which the shared folder function is enabled, as an image forming apparatus whose pattern file is to be updated preferentially.

9. The image forming apparatus according to claim 2, wherein
the apparatus information includes information regarding an installation location of the image forming apparatus, and
the controller selects, based on the apparatus information, another image forming apparatus installed at a position closest to the image forming apparatus itself, as an image forming apparatus whose pattern file is to be updated next on a priority basis.

10. The image forming apparatus according to claim 2, wherein
the apparatus information includes status information indicating a status of the image forming apparatus, and
the controller, based on the status information, selects an image forming apparatus that is not executing a job, as an image forming apparatus whose pattern file is to be updated preferentially.

11. The image forming apparatus according to claim 3, wherein
the controller acquires, from the storage device, an urgency level regarding the latest version of the pattern file, and outputs, to another image forming apparatus in accordance with the urgency level, a prohibition instruction that prohibits the another image forming apparatus from accepting a job.

12. The image forming apparatus according to claim 11, wherein
when an image forming apparatus that has output the prohibition instruction and an image forming apparatus that has not output the prohibition instruction coexist, the controller sets the priority of the image forming apparatus that has not output the prohibition instruction higher than the priority of the image forming apparatus that has output the prohibition instruction.

13. The image forming apparatus according to claim 5, further comprising:
an operation part that receives a user operation, wherein
after notifying the user, when the controller detects, via the operation part, an operation by which the user specifies an image forming apparatus that is to next update the pattern file, the controller outputs a prohibition instruction that prohibits the image forming apparatus specified by the user from accepting a job.

14. A control method of an image forming apparatus that performs virus detection processing on data using a pattern file stored in advance, the control method comprising:
when updating the pattern file, selecting, on a priority basis, an image forming apparatus whose pattern file is to be updated preferentially from among a plurality of image forming apparatuses including another image forming apparatus connected to a network and the image forming apparatus itself; and
notifying a user of the selected image forming apparatus.

15. The control method according to claim 14, further comprising:
when updating the pattern file, acquiring apparatus information regarding other image forming apparatuses; and
selecting an image forming apparatus whose pattern file is to be updated preferentially based on the apparatus information.

16. The control method according to claim 14, further comprising:
acquiring the pattern file from a storage device storing a latest version of the pattern file; and
updating the pattern file stored in advance with the acquired pattern file from the storage device.

17. The control method according to claim 16, wherein
before acquiring the pattern file from the storage device, the control method selects the image forming apparatus whose pattern file is to be updated preferentially from among the plurality of image forming apparatuses including the another image forming apparatus and the image forming apparatus itself

18. The control method according to claim 16, wherein
after acquiring the pattern file from the storage device, the control method selects the image forming apparatus whose pattern file is to be updated next preferentially from among other image forming apparatuses connected to the network.

19. The control method according to claim 15, wherein
the apparatus information includes information indicating whether a confidential-information holding function is enabled or disabled, and
the control method selects the image forming apparatus in which the confidential-information holding function is enabled, as an image forming apparatus whose pattern file is to be updated preferentially.

20. A non-transitory computer-readable recording medium storing a program that is executed by an image forming apparatus that performs virus detection processing on data using a pattern file stored in advance, the program causing the image forming apparatus to perform:
when updating the pattern file, selecting, on a priority basis, an image forming apparatus whose pattern file is to be updated preferentially from among a plurality of image forming apparatuses including another image forming apparatus connected to a network and the image forming apparatus itself; and
notifying a user of the selected image forming apparatus.
